(19) United States
(12) Patent Application Publication
(10) Pub. No.: US 2019/0035157 A1
(43) Pub. Date: Jan. 31, 2019

(54) HEAD-UP DISPLAY APPARATUS AND OPERATING METHOD THEREOF

(71) Applicant: SAMSUNG ELECTRONICS CO., LTD., Suwon-si (KR)

(72) Inventors: Jaeseung CHUNG, Suwon-si (KR); Dongouk KIM, Pyeongtaek-si (KR); Joonyong PARK, Suwon-si (KR); Geeyoung SUNG, Daegu (KR); Bongsu SHIN, Seoul (KR); Sunghoon LEE, Seoul (KR); Hongseok LEE, Seoul (KR)

(73) Assignee: SAMSUNG ELECTRONICS CO., LTD., Suwon-si (KR)

(21) Appl. No.: 16/046,033

(22) Filed: Jul. 26, 2018

(30) Foreign Application Priority Data
Jul. 26, 2017 (KR) 10-2017-0094972

(51) Int. Cl. G06T 19/00; G02B 27/01

(52) U.S. Cl. CPC G06T 19/006; G02B 2027/0127; G02B 27/0101

(57) ABSTRACT

Provided are head-up display apparatuses and operating methods thereof. The head-up display apparatus simultaneously outputs a plurality of object images on different regions from each other on a screen, generates, by using an optical characteristic, depth information with respect to the object images to sequentially change depth information of at least two of the object images, and converges the object images having depth information and the reality environment into a single region by changing at least one of an optical path of the object images having the depth information and an optical path of the reality environment.

### CROSS-REFERENCE TO RELATED APPLICATION

This application claims the priority from Korean Patent Application No. 10-2017-0094972, filed on Jul. 26, 2017, in the Korean Intellectual Property Office, the disclosure of which is incorporated herein in its entirety by reference.

### BACKGROUND

### 1. Field

Example embodiments of the present disclosure relate to display apparatuses, and more particularly, to head-up display apparatuses and operating methods thereof.

### 2. Description of the Related Art

With the start of the automotive electronic component business, interest in head-up displays that more effectively provide various information to a driver has constantly increased. Various head-up displays have been developed and commercialized, and also, automakers have released vehicles including built-in head-up displays.

Head-up displays may be divided into displays using a combiner and displays directly using a windshield. An image to be displayed may be an object image or a 3D image. According to the current technological level, a widely used method for head-up displays is a floating method in which a 2D image is floated above a dashboard by using a mirror or a 2D image is directly projected on a dashboard.

However, as a user's level of expectation increases with technological advances, demands for larger images that overlap frontal objects have increased. To address this request, studies for projecting a 3D image in front of a user have been conducted.

### SUMMARY

Example embodiments provide head-up display apparatuses configured to provide a plurality of object images of which depth information is sequentially changed and operating methods of the same.

Example embodiments provide head-up display apparatuses configured to provide images to a user by matching an object in a real environment with the object images.

According to an aspect of an example embodiment there is provided a head-up display apparatus including a spatial light modulator configured to simultaneously output a plurality of object images to different regions from each other, a depth generation member configured to generate depth information with respect to the plurality of object images using an optical characteristic to sequentially change depth information of at least two of the object images from among the plurality of object images in a direction perpendicular to a viewing angle, and an image converging member configured to converge the plurality of object images having the depth information and a reality environment on a single region by changing at least one of an optical path of the plurality of object images having the depth information and an optical path of the reality environment.

The depth generation member may generate depth information of the plurality of object images to increase the depth information of the plurality of object images from a lower region to an upper region of a viewing angle.

The depth generation member may generate depth information with respect to the plurality of object images to be provided in a horizontal direction of the viewing angle, wherein the plurality of object images have same depth information.

The depth generation member may generate depth information with respect to the plurality of object images to change the depth information in units of plurality of object images.

The optical characteristic may include at least one of refraction, diffraction, reflection, and scattering of light.

The optical characteristic of the depth generation member may change corresponding to regions of the depth generation member.

The optical characteristic of the depth generation member may be changed in a direction corresponding to a vertical direction of the viewing angle.

The depth generation member may include a first region that generates first depth information by using a first optical characteristic, and a second region that generates second depth information different from the first depth information by using a second optical characteristic different from the first optical characteristic.

The first and second regions may be arranged in a direction corresponding to the vertical direction of the viewing angle.

The type of the first optical characteristic and the second optical characteristic may be the same, and intensities of the first optical characteristic and second characteristic may be different from each other.

The depth generation member may include at least one of an aspheric lens, an aspheric mirror, a lenticular lens, a cylindrical lens, a nano-pattern, and a meta material.

The depth generation member may control sizes of the plurality of object images based on the depth information of the plurality of object images.

The sizes of the plurality of object images may be inversely proportional to the depth information of the plurality of object images.

The image converging member may include one of a beam splitter and a transflective film.

The image converging member may include a first region, and a second region having a curved interface which is in contact with the first region.

According to an aspect of an example embodiment, there is provided an operating method of a head-up display apparatus, the operating method including simultaneously outputting a plurality of object images to different regions from each other, generating, by using an optical characteristic, depth information with respect to the plurality of object images to sequentially change depth information of at least two of the object images from among the plurality of object images, and converging the plurality of object images having depth information and the reality environment into a single region by changing at least one of an optical path of the plurality of object images having the depth information and an optical path of the reality environment.

The generating of the depth information may include generating depth information with respect to the plurality of object images to change the depth information in a vertical direction of a viewing angle.

The generating of the depth information may include generating depth information with respect to the plurality of object images to increase the depth information from a lower region to an upper region of the viewing angle.

The depth information may be changed in units of plurality of object images.

The optical characteristic may include at least one of refraction, diffraction, reflection, and scattering of light.

### BRIEF DESCRIPTION OF THE DRAWINGS

The above and/or other aspects will become apparent and more readily appreciated from the following description of the example embodiments, taken in conjunction with the accompanying drawings in which:

FIG. 1 is a schematic diagram of a head-up display apparatus according to an example embodiment;

FIG. 2 is a flowchart of an operating method of the head-up display apparatus of FIG. 1;

FIG. 3 is a diagram showing an example of a head-up display apparatus used in a vehicle according to an example embodiment;

FIG. 4 is a reference diagram explaining an example of an object image outputted from a spatial light modulator of FIG. 1;

FIG. 5 is a reference diagram for explaining a method of providing the object image of FIG. 4 by a head-up display apparatus;

FIG. 6 is a reference diagram of a depth generation member configured to generate depth information by reflection according to an example embodiment;

FIG. 7 is a reference diagram of an example depth generation member configured to generate depth information by reflection according to an example embodiment;

FIG. 8 is a reference diagram of a depth generation member configured to generate depth information by diffraction according to an example embodiment;

FIG. 9 is a diagram of a depth generation member configured to generate depth information by refraction according to an example embodiment;

FIG. 10 is a diagram of a head-up display apparatus including a magnifying member according to an example embodiment; and

FIG. 11 and FIG. 12 are drawings for explaining an example image converging member having a larger viewing angle according to an example embodiment.

### DETAILED DESCRIPTION

Head-up display apparatuses and operating methods thereof will now be described in detail with reference to the accompanying drawings. In the drawings, the widths and thicknesses of layers or regions are exaggerated for clarity and convenience of explanation. Also, like reference numerals refer to like elements throughout the detailed description.

As used in the present detailed description, the terms “comprise”, “include”, and variants thereof should be construed as being non-limiting with regard to various constituent elements and operations described in the specification such that recitations of portions of constituent elements or operations of the various constituent elements and various operations do not exclude other additional constituent elements and operations that may be useful in the head-up display apparatus and operating method thereof.

It will be understood that when an element or layer is referred to as being “on,” another element or layer may include an element or a layer that is directly and indirectly on/below and left/right sides of the other element or layer.

It will be understood that, although the terms “first”, “second”, etc. may be used herein to describe various elements, the elements should not be limited by these terms. These terms are only used to distinguish one element from another element.

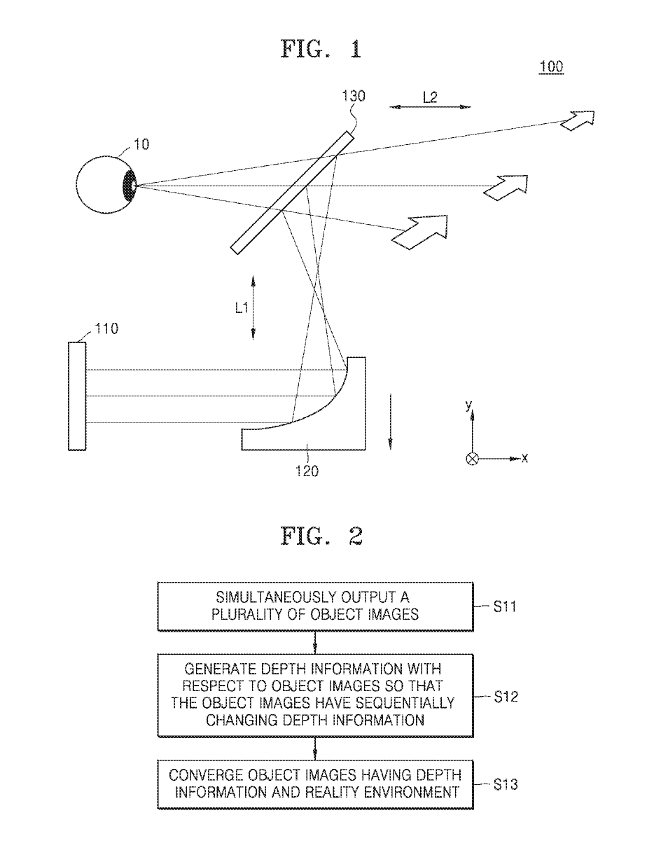

FIG. 1 is a schematic diagram of a head-up display apparatus 100 according to an example embodiment. FIG. 2 is a flowchart of an operating method of the head-up display apparatus 100 of FIG. 1.

Referring to FIG. 1 and FIG. 2, the head-up display apparatus 100 may include a spatial light modulator 110 configured to simultaneously output a plurality of object images to different regions, a depth generation member 120 configured to generate depth information with respect to a plurality of object images so that at least some of the object images of the plurality of the object images have sequentially changing depth information by using an optical characteristic, an image converging member 130 configured to converge a plurality of object images having depth information and a reality environment on a single region by changing at least one of an optical path of the object images having depth information and an optical path of the reality environment.

The spatial light modulator 110 of the head-up display apparatus 100 may simultaneously output a plurality of object images to different regions (S11), the depth generation member 120 may generate depth information to the object images so that at least some of the object images have sequentially changing depth information by using an optical characteristic (S12), and the image converging member 130 may converge the object images having depth information and a reality environment on a single region by changing at least one of an optical path of the object images having depth information and an optical path of the reality environment (S13).

The spatial light modulator 110 may output an image in units of frames. The image may be a two-dimensional (2D) image or a three-dimensional (3D) image. The 3D image may be, for example, a hologram image, a stereo image, a light field image, or an integral photography (IP) image. The image may include a plurality of partial images (hereinafter, ‘object images’) that shows an object. The object images may be outputted from different regions of the spatial light modulator 110. Thus, when the spatial light modulator 110 outputs an image frame by frame, the plurality of the object images may be simultaneously outputted to different regions. The object images may be 2D partial images or 3D partial images according to the type of the image.

The spatial light modulator 110 may be a spatial light amplitude modulator, a spatial light phase modulator, or a spatial light complex modulator that modulates both an amplitude and a phase. The spatial light modulator 110 may be a transmissive light modulator, a reflective modulator, or a transflective light modulator. For example, the spatial light modulator 110 may include a liquid crystal on silicon (LCoS) panel, a liquid crystal display (LCD) panel, a digital light projection (DLP) panel, an organic light emitting diode (OLED) panel, and a micro-organic light emitting diode (M-OLED) panel. The DLP may include a digital micromirror device (DMD).

The depth generation member 120 may generate depth information with respect to the object images so that at least some of the object images have sequentially changing depth information by using an optical characteristic. The optical characteristic may be at least one of reflection, scattering, refraction, and diffraction. The depth generation member 120 may generate depth information with respect to the object images by using regions or sub-members having different optical characteristics.

If the object images are 2D images, the depth generation member 120 may generate new depth information regarding the 2D images. If the object images are 3D images, the depth generation member 120 may change existing depth information by adding new depth information to the existing depth information.

The depth generation member 120 may generate depth information with respect to the object images so that the depth information is sequentially changed in a direction perpendicular to a viewing angle. In FIG. 1, if a Y-axis direction is a direction perpendicular to the viewing angle, the depth information may be a distance from a visual organ, such as a pupil of a user, to an object image recognized by the visual organ. If the object image is a 3D image, the depth information may be an average distance from a visual organ to an object image recognized by the visual organ.

The image converging member 130 may converge a plurality of object images having depth information and a reality environment on a single region by changing at least one of an optical path L1 of the object images having depth information and an optical path L2 of the reality environment. The single region may be an ocular organ of a user, that is, an eye. The image converging member 130 may transmit a plurality of lights according to the plural optical paths L1 and L2 to a pupil of a user. For example, the image converging member 130 may transmit and guide light corresponding to a plurality of object images having depth information of the first optical path L1 and external light corresponding to a reality environment of the second optical path L2 to an ocular organ 10 of the user.

Light of the first optical path L1 may be light reflected by the image converging member 130, light of the second optical path L2 may be light passed through the image converging member 130. The image converging member 130 may be a transflective member having a combined characteristic of light transmission and light reflection. For example, the image converging member 130 may include a beam splitter or a transflective film. In FIG. 1, it is depicted that the image converging member 130 is a beam splitter, but example embodiments are not limited thereto, and the image converging member 130 may have various configurations.

The plurality of object images having depth information transmitted by light of the first optical path L1 may be object images formed and provided by the head-up display apparatus 100. The object images having depth information may include virtual reality or virtual information as a ‘display image’. A reality environment transmitted by light of the second optical path L2 may be an environment surrounding a user through the head-up display apparatus 100. The reality environment may include a front view in front of a user and may include a background of the user. Accordingly, the head-up display apparatus 100 according to an example embodiment may be applied to a method of realizing an augmented reality (AR) or a mixed reality (MR). In particular, when the head-up display apparatus 100 is applied to a vehicle, the reality environment may include, for example, roads. When the reality environment is viewed by a user in the vehicle, a distance to the reality environment may vary according to the position of the eye of the user.

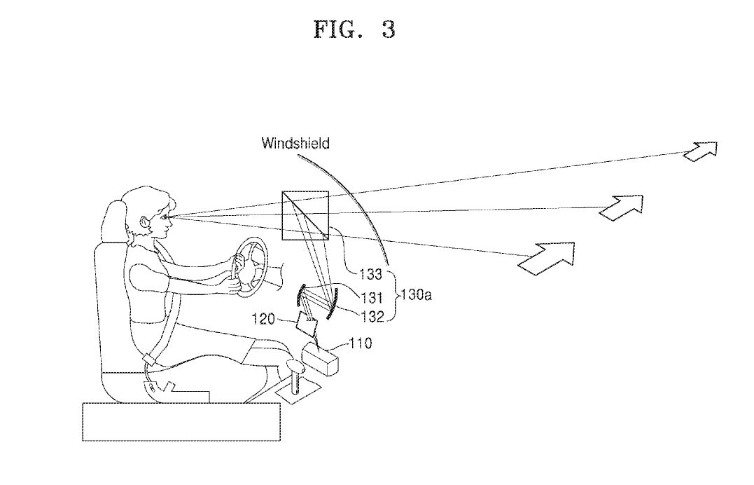

FIG. 3 is a diagram showing an example of a head-up display apparatus applied to a vehicle. As depicted in FIG. 3, after arranging the spatial light modulator 110 and the depth generation member 120 on a region of a vehicle, and when at least one of mirrors 131 and 132 and a beam splitter 133 are used as an image converging member 130a, a plurality of object images and external object images having depth information may be transmitted to an eye of the driver. The at least one of mirrors 131 and 132 may include a foldable mirror and an anisotropy mirror.

When a user, for example, a driver, uses a head-up display apparatus, a distance from an eye of the user to a reality environment may vary according to a height of a viewing angle. For example, the reality environment at a lower region of the viewing angle may be a road in front of a bonnet of the vehicle or directly in front of the vehicle, and the reality environment at a middle region of the viewing angle may be a road further away from the road of the lower region of the viewing angle. The reality environment at an upper region of the viewing angle may be external environments including the sky. That is, a distance to the reality environment may vary according to the viewing angle, and a distance to the reality environment may gradually increase from the lower region to the upper region of the viewing angle.

The head-up display apparatus 100 according to an example embodiment may provide object images having depth information different from each other according to regions of a viewing angle. For example, the head-up display apparatus 100 may provide object images having depth information gradually increasing from a lower region to an upper region of a viewing angle. In this way, the object images and subjects, for example, roads or buildings in the reality environment may be matched to some degree, and thus, a user may more comfortably recognize the object images.

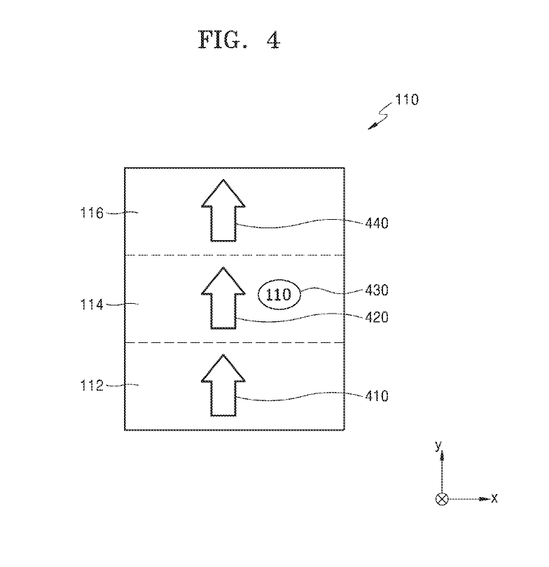

FIG. 4 is a reference diagram for explaining an object image outputted from the spatial light modulator 110 of FIG. 1. As depicted in FIG. 4, the spatial light modulator 110 may output an image frame by frame. The image may be a 2D image or a 3D image. In FIG. 4, the spatial light modulator 110 is depicted as outputting a 2D image, but example embodiments are not limited thereto. In FIG. 4, four object images are depicted. For example, a first object image 410 may be outputted in a first region 112, second and third object images 420 and 430 may be outputted in a second region 114, and a fourth object image 440 may be outputted in a third region 116 of the spatial light modulator 110. The first through fourth object images 410, 420, 430, and 440 outputted from the spatial light modulator 110 may have the same size or different sizes from one another.

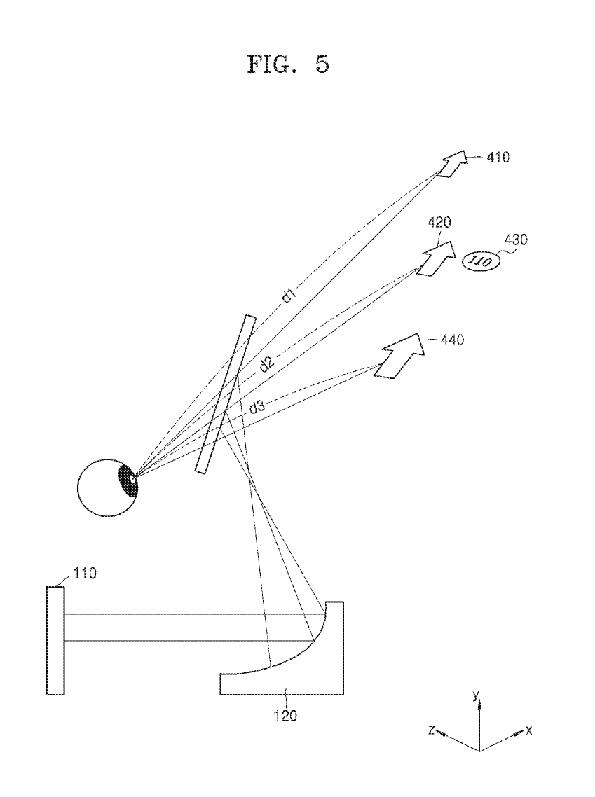

FIG. 5 is a reference diagram for explaining a method of outputting the first through fourth object images 410, 420, 430, and 440 of FIG. 4 by a head-up display apparatus. As depicted in FIG. 5, the head-up display apparatus 100 may output the first through fourth object images 410, 420, 430, and 440 in a viewing angle. For example, the depth generation member 120 of the head-up display apparatus 100 may generate depth information for the first object image 410 to have a first depth information d1, may generate depth information for the second and third object images 420 and 430 to have a second depth information d2, and may generate depth information for the fourth object image 440 to have a third depth information d3. In FIG. 1, when the depth generation member 120 generates depth information, the depth generation member 120 may reverse relative positions of the first through fourth object images 410, 420, 430, and 440. For example, the depth generation member 120 may provide the first object image 410 outputted in the first region 112 which is a lower region of the spatial light modulator 110 in the upper region of the viewing angle by reversing the region of the first object image 410. Also, the depth generation member 120 may provide the fourth object image 440 outputted in the third region 116, which is an upper region of the spatial light modulator 110, in the lower region of the viewing angle by reversing the region of the fourth object image 440.

In FIG. 4 and FIG. 5, it is depicted that a vertical direction of the spatial light modulator 110 and a vertical direction of the viewing angle are opposite directions, but example embodiments are not limited thereto. Various optical elements may be arranged between the spatial light modulator 110 and the image converging member 130, and thus, the vertical direction of the spatial light modulator 110 and the vertical direction of the viewing angle may be the same. Due to the arrangement of optical elements, a horizontal direction of the spatial light modulator 110 and the vertical direction of the viewing angle may be the same. Hereinafter, an arrangement direction of object images outputted from the spatial light modulator 110 may be defined as a direction corresponding to the arrangement direction of the object images provided in the viewing angle. That is, a −y-axis direction of the spatial light modulator 110 may correspond to a +y-axis direction of a viewing angle.

Also, the depth generation member 120 may generate different depth information with respect to the first through fourth object images 410, 420, 430, and 440 according to regions of a viewing angle. For example, when the first, second, and fourth object images 410, 420, and 440 are arranged in a vertical direction to the viewing angle, the depth generation member 120 may generate first through third depth information d1, d2, and d3 so that the first through third depth information d1, d2, and d3 are sequentially changed in the vertical direction of the viewing angle. For example, the depth generation member 120 may generate depth information such that a magnitude of the depth information is gradually reduced from the third depth information d3 to the first depth information d1. That is, the depth generation member 120 may generate depth information with respect to plurality of object images so that the depth information is gradually increased from the lower region to the upper region of the viewing angle. In this manner, the object images may be provided to different regions from each other according to the depth information.

The depth generation member 120 may generate depth information with respect to object images to be provided in the horizontal direction of a viewing angle to have equal depth information. In FIG. 5, since the second and third object images 420 and 430 have equal depth information, a user may recognize that the second and third object images 420 and 430 are located at the same distance.

Also, the depth generation member 120 may change sizes of the object images in the vertical direction of the viewing angle. For example, the depth generation member 120 may control the size of the object image in the horizontal direction of the viewing angle so that the size of the object image is gradually reduced from the lower region to the upper region of the viewing angle. Also, the depth generation member 120 may control the sizes of the object images to be equal in the horizontal direction of the viewing angle. In this manner, the head-up display apparatus 100 may provide an object image by changing a larger size depth information to a smaller size depth information and by changing a smaller size depth information to a larger size depth information. Thus, since this change corresponds to changing a size of a subject according to the perspective in a reality environment, a user may more easily recognize the object images.

The size control of depth information may be realized as one body with the depth generation member 120 that generates depth information or may be separately realized. The size control of depth information described above may also be generated based on an optical characteristic. The depth generation member 120 may control the size of depth information based on an optical characteristic and may change the size inversely proportional to the depth information. However, example embodiments are not limited thereto.

As described above, the depth generation member 120 may generate depth information with respect to object images by using an optical characteristic. The optical characteristic may include at least one of reflection, scattering, refraction, and diffraction of light. According to the optical characteristic, a focal distance of the depth generation member 120 may be changed, and thus, an image forming location of an object image may be changed. Therefore, the depth generation member 120 may generate depth information based on the optical characteristic.

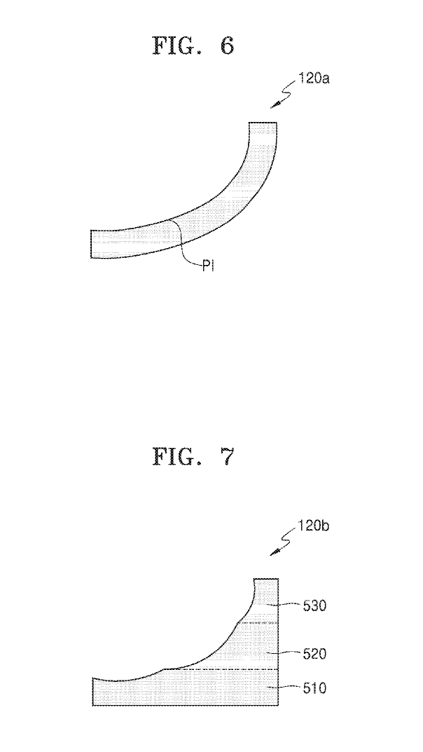

FIG. 6 is a reference diagram of a depth generation member 120a configured to generate depth information by reflection. Referring to FIG. 6, the depth generation member 120a may be an aspheric lens having different curvatures. The curvature of the depth generation member 120a may vary corresponding to regions of a viewing angle. In detail, a curvature with respect to an incident surface P1 of the depth generation member 120a may gradually change corresponding to a vertical direction of the viewing angle. For example, the curvature with respect to the incident surface P1 of the depth generation member 120a may be gradually reduced in a direction corresponding to a direction from the lower region to the upper region of the viewing angle. In FIG. 6, the direction corresponding to the direction from the lower region to the upper region is depicted as a −y-axis. That is, the curvature with respect to the incident surface P1 of the depth generation member 120a depicted in FIG. 6 may gradually increase in a +y-axis direction. The curvature is depicted as continuously changing, but example embodiments are not limited thereto. That is, the curvature may change discontinuously.

FIG. 7 is a reference diagram of an example depth generation member 120b configured to generate depth information by reflection. Referring to FIG. 7, the depth generation member 120b may include a first region 510 having a first curvature, a second region 520 having a second curvature, and a third region 530 having a third curvature. The curvature may gradually increase from the first curvature to the third curvature. An object image reflected at the first region 510 may be provided on an upper region of a viewing angle, an object image reflected at the second region 520 may be provided on a middle region of the viewing angle, and an object image reflected at the third region 530 may be provided on a lower region of the viewing angle. The object image reflected at the first region 510 may be formed further away from a user than the object image reflected at the second region 520, and the object image reflected at the second region 520 may be formed further away from the user than the object image reflected at the third region 530 due to the different sizes of the curvatures. Thus, a head-up display apparatus may provide an object image having gradually increased depth information from the lower region to the upper region of the viewing angle.

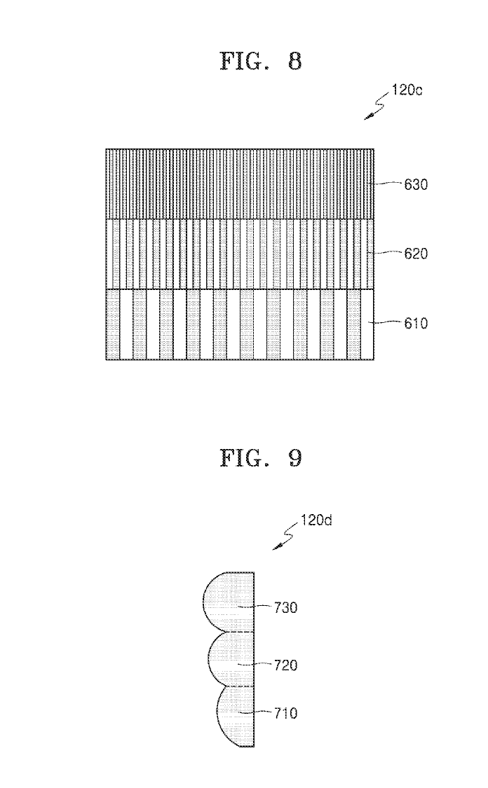

FIG. 8 is a reference diagram of a depth generation member 120c configured to generate depth information by diffraction. As depicted in FIG. 8, in the depth generation member 120c, different regions may have different diffraction characteristics from each other. The depth generation member 120c may be a lenticular lens in which each region has a different diffraction coefficient. The lenticular lens includes a plurality of sub-cylindrical lenses. A diffraction coefficient may be determined according to a material of a lens, a curvature of a lens, or gaps between lenses. For example, the depth generation member 120c may include a first region 610 having a first diffraction coefficient, a second region 620 having a second diffraction coefficient, and a third region 630 having a third diffraction coefficient. The change of the first through third diffraction coefficients may be in a direction corresponding to a direction from the lower region to the upper region of the viewing angle. Also, the diffraction coefficient of the depth generation member 120c may be changed according to depth information of an object image to increase from the lower region to the upper region. The depth generation member 120c that uses diffraction may be realized as a meta-material or a nano-pattern besides the lenticular lens.

The depth generation member 120c realized as a lenticular lens or a meta-material may be formed as one body with the spatial light modulator 110. When the spatial light modulator 110 outputs a 3D object image, the spatial light modulator 110 may output an object image, depth information of which is sequentially changed in each region.

FIG. 9 is a diagram of a depth generation member 120d configured to generate depth information based on light refraction. As depicted in FIG. 9, the depth generation member 120d may include a plurality of cylindrical lenses that may have different refraction characteristics from one another. A refraction coefficient may be determined according to a material or curvature of the lenses. For example, the depth generation member 120d may include a first region 710 having a first refraction coefficient, a second region 720 having a second refraction coefficient, and a third region 730 having a third refraction coefficient. The change of the refraction coefficient may be in a direction corresponding to a perpendicular direction of a viewing angle. Also, the refraction coefficient of the depth generation member 120d may be changed so that depth information of an object image increases from a lower region to an upper region of a viewing angle.

As described above, the depth generation members 120, 120a, 120c, and 120d may provide object images having different depth information from one another according to a height of a viewing angle since an optical characteristic of the viewing angle is changed from a lower region to an upper region. According to an example embodiment, the depth generation member 120, 120a, 120c, and 120d may have the same optical characteristic in a direction corresponding to a vertical direction of the viewing angle. Thus, object images having the same depth information may be provided in the same horizontal direction of the viewing angle.

In FIG. 6 through FIG. 9, a single depth generation member is depicted for convenience of explanation, but example embodiments are not limited thereto. The depth generation member may include a combination of a plurality of optical devices having different optical characteristics. For example, the depth generation member may generate sequentially changing depth information via the plurality of optical devices.

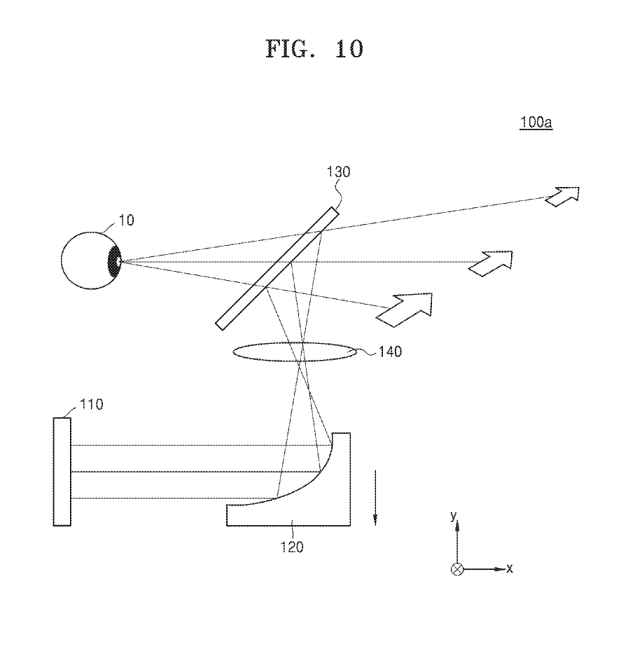

FIG. 10 is a diagram of a head-up display apparatus 100a including a magnifying member 140 according to an example embodiment.

The spatial light modulator 110 is may be relatively small, and object images outputted from the spatial light modulator 110 and a plurality of object images having depth information generated from the depth generation member 120 may also be relatively small. The head-up display apparatus 100a according to an example embodiment may further include the magnifying member 140 arranged between the depth generation member 120 and the image converging member 130, and configured to magnify the object images having depth information. The magnifying member 140 may control the magnifying rate of each of the object images in a direction corresponding to a vertical direction of a viewing angle.

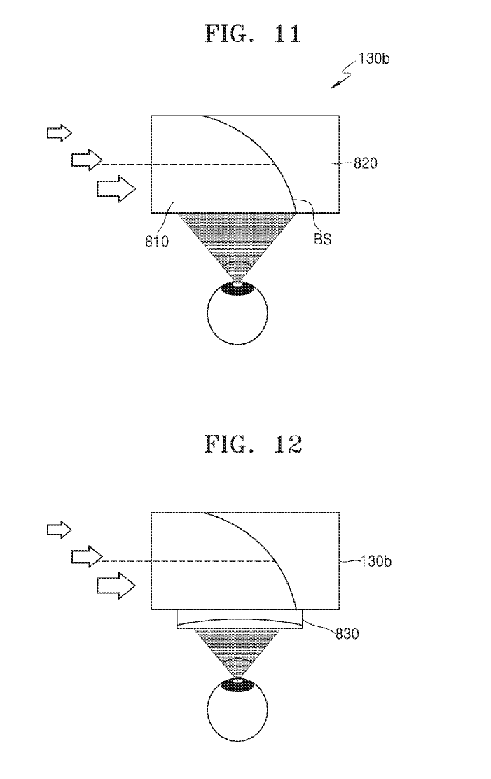

FIGS. 11 and 12 are drawings for explaining an image converging member 130 having a large viewing angle according to an embodiment of the inventive concept. The image converging member 130b depicted in FIG. 11 may include a plurality of regions including different materials from one another. For example, the image converging member 130b may include a first region 810 and a second region 820, wherein an interface BS between the first region 810 and the second region 820 is a curved surface. A center of a curvature of the curved surface may be close to a plurality of object images having depth information. The boundary surface BS may be coated with a reflection material. Thus, a user may recognize further wide object images.

Also, as depicted in FIG. 12, a lens 830 may further be arranged between the image converging member 130b and an ocular organ of a user. Since the lens 830 is arranged closer to the ocular organ of the user, a focal distance of the lens 830 may be smaller than a diameter of the lens 830. As a result, a wide angle of view or a wide field of view may be readily ensured. The lens 830 may be an anisotropy lens. According to an embodiment, the lens 830 may be a polarization-dependent birefringent lens. Thus, the lens 830 may operate as a lens with respect to object images having depth information and as a plate with respect to external object images.

The head-up display apparatus described above may be an element of a wearable apparatus. As an example, the head-up display apparatus may be applied to a head mounted display (HMD). Also, the head-up display apparatus may be applied to a glasses-type display or a goggle-type display. Wearable devices may be operated via smart phones by being interlocked with or connected thereto.

A head-up display apparatus according to an example embodiment may generate, by using an optical characteristic, depth information with respect to a plurality of object images simultaneously outputted from a spatial light modulator. Also, the head-up display apparatus according to an example embodiment may provide an image to a user that may be more comfortably viewed by matching an object in a reality environment with object images therein.

Additionally, the head-up display apparatuses according to an example embodiment may be applied to various electronic devices, and also, may be applied to an automotive apparatus, such as a vehicle or general equipment. Also, the head-up display apparatuses according to an example embodiment may be used in various fields. Also, the head-up display apparatus according to an example embodiment may be used to realize an augmented reality (AR) or a mixed reality (MR), and also, may be applied to other fields. In other words, the head-up display apparatus according to an example embodiment may be applied to a multi-object image display that simultaneously displays a plurality of object images, although the multi-object image display is not an AR display or MR display.

While the example embodiments have been shown and described, it will be understood by those of ordinary skill in the art that various changes in form and details may be made therein without departing from the spirit and scope of the present disclosure as defined by the appended claims, and their equivalents.

What is claimed is:

1. A head-up display apparatus comprising:
a spatial light modulator configured to simultaneously output a plurality of object images to different regions from each other;
a depth generation member configured to generate depth information with respect to the plurality of object images using an optical characteristic to sequentially change depth information of at least two of the object images from among the plurality of object images in a direction perpendicular to a viewing angle; and
an image converging member configured to converge the plurality of object images having the depth information and a reality environment on a single region by changing at least one of an optical path of the plurality of object images having the depth information and an optical path of the reality environment.

2. The head-up display apparatus of claim 1, wherein the depth generation member generates depth information of the plurality of object images to increase the depth information of the plurality of object images from a lower region to an upper region of a viewing angle.

3. The head-up display apparatus of claim 1, wherein the depth generation member generates depth information with respect to the plurality of object images to be provided in a horizontal direction of the viewing angle,
wherein the plurality of object images have same depth information.

4. The head-up display apparatus of claim 1, wherein the depth generation member generates depth information with respect to the plurality of object images to change the depth information in units of plurality of object images.

5. The head-up display apparatus of claim 1, wherein the optical characteristic comprises at least one of refraction, diffraction, reflection, and scattering of light.

6. The head-up display apparatus of claim 1, wherein the optical characteristic of the depth generation member changes corresponding to regions of the depth generation member.

7. The head-up display apparatus of claim 6, wherein the optical characteristic of the depth generation member is changed in a direction corresponding to a vertical direction of the viewing angle.

8. The head-up display apparatus of claim 1, wherein the depth generation member comprises:
a first region that generates first depth information by using a first optical characteristic; and
a second region that generates second depth information different from the first depth information by using a second optical characteristic different from the first optical characteristic.

9. The head-up display apparatus of claim 8, wherein the first and second regions are arranged in a direction corresponding to the vertical direction of the viewing angle.

10. The head-up display apparatus of claim 8, wherein a type of the first optical characteristic and the second optical characteristic are the same, and intensities of the first optical characteristic and second characteristic are different from each other.

11. The head-up display apparatus of claim 1, wherein the depth generation member comprises at least one of an aspheric lens, an aspheric mirror, a lenticular lens, a cylindrical lens, a nano-pattern, and a meta material.

12. The head-up display apparatus of claim 1, wherein the depth generation member controls sizes of the plurality of object images based on the depth information of the plurality of object images.

13. The head-up display apparatus of claim 12, wherein the sizes of the plurality of object images are inversely proportional to the depth information of the plurality of object images.

14. The head-up display apparatus of claim 1, wherein the image converging member comprises one of a beam splitter and a transflective film.

15. The head-up display apparatus of claim 1, wherein the image converging member comprises:
a first region; and
a second region having a curved interface which is in contact with the first region.

16. An operating method of a head-up display apparatus, the operating method comprising:
simultaneously outputting a plurality of object images to different regions from each other;
generating, by using an optical characteristic, depth information with respect to the plurality of object images to sequentially change depth information of at least two of the object images from among the plurality of object images; and
converging the plurality of object images having depth information and the reality environment into a single region by changing at least one of an optical path of the plurality of object images having the depth information and an optical path of the reality environment.

17. The operating method of claim 16, wherein the generating of the depth information comprises generating depth information with respect to the plurality of object images to change the depth information in a vertical direction of a viewing angle.

18. The operating method of claim 17, wherein the generating of the depth information comprises generating depth information with respect to the plurality of object images to increase the depth information from a lower region to an upper region of the viewing angle.

19. The operating method of claim 16, wherein the depth information is changed in units of plurality of object images.

20. The operating method of claim 16, wherein the optical characteristic comprises at least one of refraction, diffraction, reflection, and scattering of light.
